(19) United States
(12) Patent Application Publication
(10) Pub. No.: US 2019/0375655 A1
(43) Pub. Date: Dec. 12, 2019

(54) NEGATIVE THERMAL EXPANSION MATERIAL AND COMPOSITE MATERIAL

(71) Applicant: National University Corporation Nagoya University, Nagoya-shi (JP)

(72) Inventors: Koshi Takenaka, Nagoya-shi (JP); Yoshihiko Okamoto, Nagoya-shi (JP); Yasunori Yokoyama, Nagoya-shi (JP); Naoyuki Katayama, Nagoya-shi (JP)

(21) Appl. No.: 16/433,269

(22) Filed: Jun. 6, 2019

(30) Foreign Application Priority Data
Jun. 8, 2018 (JP) 2018-110035

(51) Int. Cl. C01G 49/00; C01G 31/00; C01G 39/00; C09K 5/14

(52) U.S. Cl. CPC C01G 49/009; C01G 31/006; C01G 39/006; C01P 2002/76; C01P 2002/72; C01P 2006/32; C09K 5/14

(57) ABSTRACT

A negative thermal expansion material according to an embodiment is represented by a general formula (1): Cu₂₋ₓRₓV₂O₇ (R is at least one element selected from Zn, Ga, and Fe) and includes an oxide sintered compact whose linear expansion coefficient is −10 ppm/K or less.

### CROSS-REFERENCE TO RELATED APPLICATIONS

This application is based upon and claims the benefit of priority from the prior Japanese Patent Application No. 2018-110035, filed on Jun. 8, 2018, the entire contents of which are incorporated herein by reference.

### BACKGROUND OF THE INVENTION

### 1. Field of the Invention

The present invention relates to negative thermal expansion materials.

### 2. Description of the Related Art

In general, it is known that substances thermally expand as the temperature rises. However, advanced development of industrial technology in recent years requires control over even thermal expansion to which solid materials can be considered to be destined. Even a rate of change of about 10 ppm (10⁻⁵) in length, which is small in the general sense, is a big problem in the field of semiconductor device manufacturing where high accuracy at a nanometer level is required, precision instruments whose functions are greatly affected by slight distortion of parts, and so on. Further, in a device in which a plurality of materials are combined, other problems such as interface peeling and disconnection may also occur due to differences in thermal expansion of the respective constituent materials.

On the other hand, negative thermal expansion materials (with a negative coefficient of thermal expansion) are also known whose lattice volume decreases as the temperature rises. For example, a composite material is known that suppresses thermal expansion by mixing α-Cu₂V₂O₇ having a negative coefficient of thermal expansion and Al having a positive coefficient of thermal expansion (Non-patent Document 1).
[Non-patent Document 1] N. Zhang et al., Tailored thermal expansion and electrical properties of α-Cu₂V₂O₇/Al, Ceramics International, 2016, 42, p. 17004-17008

It is known that α-Cu₂V₂O₇ exhibits negative thermal expansion of −5 to −6 ppm/° C. in a linear expansion coefficient in a temperature range from room temperature to 200° C. However, there is room for improvement in the magnitude of the linear expansion coefficient of α-Cu₂V₂O₇ and the temperature range in which negative thermal expansion is exhibited.

### SUMMARY OF THE INVENTION

In this background, a purpose of the present disclosure is to provide a new material that exhibits large negative thermal expansion in a wide temperature range.

A negative thermal expansion material according to one embodiment of the present disclosure is represented by a general formula (1): Cu₂₋ₓRₓV₂O₇ (R is at least one element selected from Zn, Ga, and Fe) and includes an oxide sintered compact whose linear expansion coefficient is −10 ppm/K or less.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram showing the X-ray diffraction pattern of Cu₂V₂O₇ containing no Zn as a constituent element and the X-ray diffraction pattern of Cu_{1.8}Zn_{0.2}V₂O₇ containing Zn as a constituent element;

FIG. 2 is a diagram showing the thermal expansion property of α-Cu₂V₂O₇ and the thermal expansion property of β-Cu_{1.8}Zn_{0.2}V₂O₇;

FIG. 3 is a diagram showing the thermal expansion properties of oxide sintered compacts expressed by a general formula (1): Cu₂₋ₓRₓV₂O₇ (R is at least one element selected from Zn, Ga, and Fe) with different substitution elements or a general formula (2): Cu₂V₂₋ₓMoₓO₇;

FIG. 4 is a diagram showing the thermal expansion property of each sample having a different substitution amount x when the substitution element is Zn;

FIG. 5 is a diagram showing the thermal expansion property of a composite material according to the present embodiment; and

FIG. 6 is a schematic diagram for explaining a significant discrepancy between ΔV/V (unit cell) and ΔV/V (bulk).

### DETAILED DESCRIPTION OF THE INVENTION

The invention will now be described by reference to the preferred embodiments. This does not intend to limit the scope of the present invention, but to exemplify the invention.

The present inventors have focused on a Cu₂V₂O₇ system as a candidate for a substance that exhibits negative thermal expansion. Although α-Cu₂V₂O₇ which has an orthorhombic crystal structure has drawn interest as a multiferroic substance in which both a ferroelectric property and a weak paramagnetic property coexist, anisotropic thermal deformation of the crystal lattice can be seen, which is believed to be due to dielectric instability, in a relatively wide temperature range including room temperature and temperature higher than the room temperature. As a result, negative thermal expansion appears where the unit cell volume contracts as the temperature rises in a wide temperature range.

By substituting Cu₂V₂O₇ with various elements, a monoclinic β phase and a triclinic y phase in addition to an orthorhombic α phase can be realized. Accordingly, the present inventors have found that when a part of the Cu site or the V site is substituted with another element, negative thermal expansion properties that cannot be realized in the conventional α-Cu₂V₂O₇ system are expressed and have devised a negative thermal expansion material illustrated in the following.

A negative thermal expansion material according to an embodiment of the present disclosure is represented by a general formula (1): Cu₂₋ₓRₓV₂O₇ (R is at least one element selected from Zn, Ga, and Fe) and includes an oxide sintered compact whose linear expansion coefficient is −10 (ppm/K) or less.

According to this embodiment, a negative linear expansion coefficient can be realized whose absolute value is larger than that of the linear expansion coefficient of a-Cu₂V₂O₇ in which Cu is not substituted with R.

In the general formula (1), x may be 0.1 to 1. Thereby, a linear expansion coefficient can be realized whose absolute value is larger than that of the linear expansion coefficient of α-Cu₂V₂O₇ in which Cu is not substituted with R.

R may be Zn. This allows a p-phase (monoclinic phase) crystal structure to be obtained that is stable at room temperature.

In the general formula (1), x may be 0.15 to 1. Thereby, a linear expansion coefficient can be realized whose absolute value is larger than that of the linear expansion coefficient of α-Cu₂V₂O₇ in which Cu is not substituted with R.

Another embodiment of the present disclosure also relates to a negative thermal expansion material. This negative thermal expansion material is represented by a general formula (2): Cu₂V₂₋ₓMoₓO₇, and includes an oxide sintered compact whose linear expansion coefficient is −10 ppm/K or less.

According to this embodiment, a negative linear expansion coefficient can be realized whose absolute value is larger than that of the linear expansion coefficient of a-Cu₂V₂O₇ in which Cu is not substituted with R.

X may be 0.1 to 0.3. Thereby, a linear expansion coefficient can be realized whose absolute value is larger than that of the linear expansion coefficient of α-Cu₂V₂O₇ in which Cu is not substituted with R.

The oxide sintered compact may be in a monoclinic β phase.

The linear expansion coefficient may be −10 ppm/K or less in a temperature range of 100 to 700K.

Another embodiment of the present disclosure relates to a composite material. This composite material includes a negative thermal expansion material and a positive thermal expansion material having a positive linear expansion coefficient. This allows for the realization of the composite material in which volume change with respect to temperature change is suppressed.

Hereinafter, an embodiment for carrying out the present disclosure will be described in detail with reference to the accompanying drawing and the like.

(Method for Preparing Samples)

First, a polycrystalline sintered compact (ceramics) sample of α-Cu₂V₂O₇ and a polycrystalline sintered compact (ceramics) sample of β-Cu_{1.8}Zn_{0.2}V₂O₇ were prepared using a solid phase reaction method. More specifically, CuO, ZnO, and V₂O₅, which were weighed at a stoichiometric molar ratio, were mixed in a mortar and heated in the atmosphere at a temperature of 873 to 953K for 10 hours. The powder that was obtained was sintered using a spark plasma sintering (SPS) furnace (manufactured by SPS SYNTEX INC.) so as to obtain an oxide sintered compact. The sintering was performed for 5 minutes at 723K using a graphite die under vacuum (<10⁻¹ Pa).

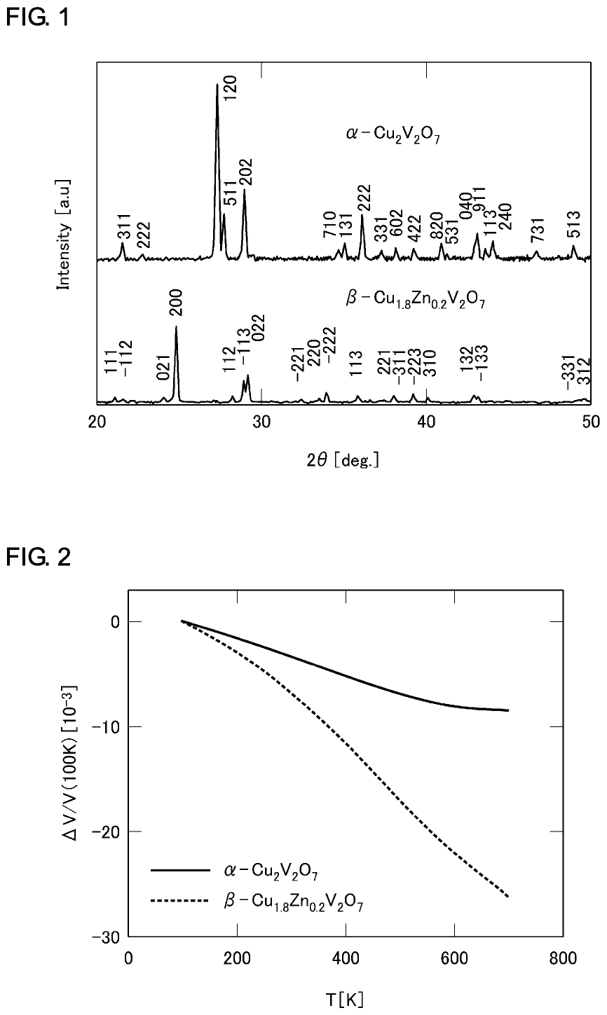

Thereafter, the crystal structure of each sample was evaluated using powder X-ray diffraction (XRD) method (measurement temperature of 295K, CuKα characteristic X-ray: wavelength λ=0.15418 nm) and a radiation light temperature change X-ray diffraction method (wavelength A=0.06521 nm). FIG. 1 is a diagram showing the X-ray diffraction pattern of Cu₂V₂O₇ containing no Zn as a constituent element and the X-ray diffraction pattern of Cu_{1.8}Zn_{0.2}V₂O₇ containing Zn as a constituent element.

As shown in FIG. 1, Cu₂V₂O₇ in which Cu is not substituted with Zn has an a phase (orthorhombic) crystal structure, and Cu_{1.8}Zn_{0.2}V₂O₇ in which a part of Cu is substituted with Zn has a β phase (monoclinic) crystal structure. As described, by substituting a part of an element of Cu₂V₂O₇ with another element, a β phase which does not stably exist unless the temperature is high (977K or more) in the Cu₂V₂O₇ composition can stably exist at room temperature.

FIG. 2 is a diagram showing the thermal expansion property of α-Cu₂V₂O₇ and the thermal expansion property of β-Cu_{1.8}Zn_{0.2}V₂O₇. The vertical axis represents a volume change ΔV/V based on a volume V at 100K. The volume change has been calculated using a linear expansion coefficient α calculated using a laser thermal expansion system (LIX-2: manufactured by ULVAC, Inc.) (measurement temperature range: 100 to 700 K). Table 1 shows the respective crystal structures and the respective values of volumetric expansion coefficients β, negative thermal expansion expression ranges ΔT (K), and total volume change amounts ΔV/V (%) of α-Cu₂V₂O₇ and β-Cu_{1.8}Zn_{0.2}V₂O₇.

TABLE 1

| | Crystal | β | ΔT | ΔV/V |
|---|---|---|---|---|
| | structure | (ppm/K) | (K) | (%) |
| α-Cu₂V₂O₇ | orthorhombic | −16 | 500 (100-600) | 0.80 |
| β-Cu_{1.8}Zn_{0.2}V₂O₇ | monoclinic | −43 | 600 (100-700) | 2.6 |

As shown in Table 1, in β-Cu_{1.8}Zn_{0.2}V₂O₇, the absolute value of the volumetric expansion coefficient β (=3a) is 2.5 or more times the absolute value of the volumetric expansion coefficient of α-Cu₂V₂O₇. Further, the total volume change amount ΔV/V of β-Cu_{1.8}Zn_{0.2}V₂O₇ is 2.6%, which is three or more times the total volume change amount of α-Cu₂V₂O₇, and it can be found that the material exhibits large negative thermal expansion. Further, while the absolute value of the linear expansion coefficient starts to decrease around when the temperature exceeds 600K in α-Cu₂V₂O₇, the linear expansion coefficient is almost constant even at 700K in β-Cu_{1.8}Zn_{0.2}V₂O₇.

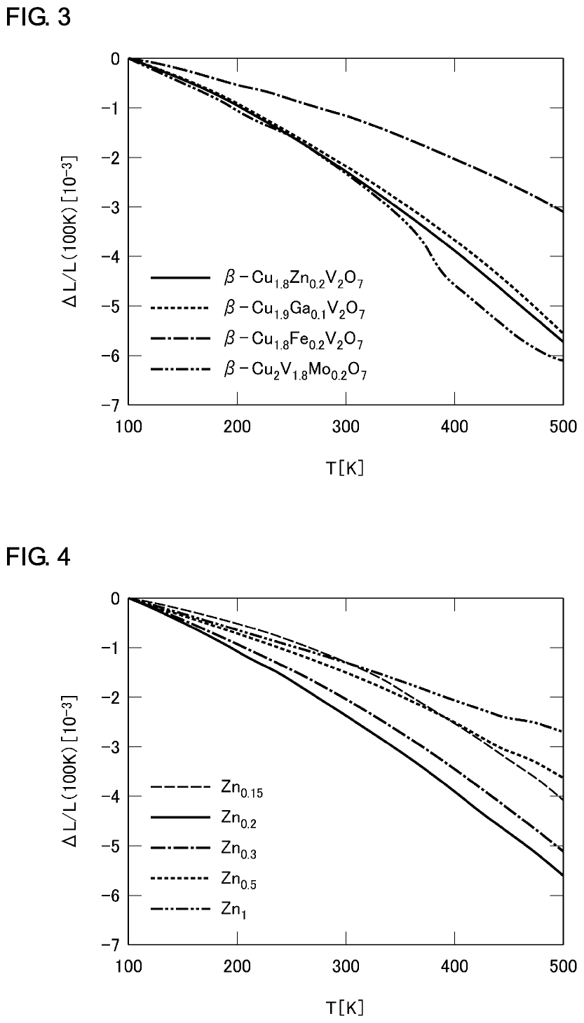

Next, the influence of a substitution element on negative thermal expansion will be described. FIG. 3 is a diagram showing the thermal expansion properties of oxide sintered compacts expressed by a general formula (1): Cu₂₋ₓRₓV₂O₇ (R is at least one element selected from Zn, Ga, and Fe) with different substitution elements or a general formula (2): Cu₂V₂₋ₓMoₓO₇. Table 2 shows the substitution elements and the respective values of the substitution amounts x, the linear expansion coefficients α, the measurement temperature ranges ΔT (K), and the total volume change amounts ΔV/V (%).

TABLE 2

| substitution | | α | ΔT | ΔV/V |
|---|---|---|---|---|
| elements | x | (ppm/K) | (K) | (%) |
| Zn | 0.2 | −14.4 | 600 (100-700) | 2.6 |
| Ga | 0.1 | −13.9 | 400 (100-500) | 1.6 |
| Fe | 0.2 | −10.3 | 400 (100-500) | 0.93 |
| Mo | 0.2 | −15.2 | 400 (100-500) | 1.8 |

As shown in Table 2, in the general formula (1) or (2), even when the substitution element was Ga, Fe, or Mo and the substitution amount x was 0.1 to 0.2, negative thermal expansion larger than that of α-Cu₂V₂O₇ was observed at least in the temperature range of 100 to 500K. More specifically, all the samples have a linear expansion coefficient of −10 ppm/K or less and can realize a negative linear expansion coefficient whose absolute value is larger than that of the linear expansion coefficient of α-Cu₂V₂O₇ in which Cu is not substituted with R. Therefore, in the general formula (1) or (2), when the substitution element is Ga, Fe, or Mo, the substitution amount x is 0.05 or more, preferably 0.1 or more, and the substitution amount x is 0.3 or less, preferably 0.2 or less.

Next, the influence of the substitution amount x of the substitution element will be described. FIG. 4 is a diagram showing the thermal expansion property of each sample having a different substitution amount x when the substitution element is Zn. Table 3 shows the substitution elements and the respective values of the substitution amounts x, the linear expansion coefficients α, the measurement temperature ranges ΔT (K), and the total volume change amounts ΔV/V (%).

TABLE 3

| substitution | | α | ΔT | Δ/V |
|---|---|---|---|---|
| elements | x | (ppm/K) | (K) | (%) |
| Zn | 0.15 | −10.2 | 400 (100-500) | 1.2 |
| Zn | 0.2 | −14.4 | 600 (100-700) | 2.6 |
| Zn | 0.3 | −14.1 | 400 (100-500) | 1.7 |
| Zn | 0.5 | −9.4 | 400 (100-500) | 1.1 |
| Zn | 1 | −6.8 | 400 (100-500) | 0.8 |

As shown in Table 3, even when the substitution amount x of the substitution element Zn of Cu₂₋ₓZnₓV₂O₇ was 0.15 to 1, negative thermal expansion larger than that of a-Cu₂V₂O₇ was observed at least in the temperature range of 100 to 500K. Note that β-Cu₂₋ₓZnₓV₂O₇ may have a linear expansion coefficient of −10 ppm/K or less and preferably −14 ppm/K or less in a temperature range of 100 to 700 K. More specifically, the substitution amount x of the substitution element Zn of Cu₂₋ₓZnₓV₂O₇ is preferably 0.15 or more and 0.5 or less and more preferably 0.2 or more and 0.3 or less.

Next, a composite material will be described that includes a negative thermal expansion material composed of an oxide sintered compact represented by the general formula (1): Cu₂₋ₓRₓV₂O₇ (R is at least one element selected from Zn, Ga, and Fe), or the general formula (2): Cu₂V₂₋ₓMoₓO₇, and a positive thermal expansion material having a positive linear expansion coefficient such as a resin, a metal, or the like.

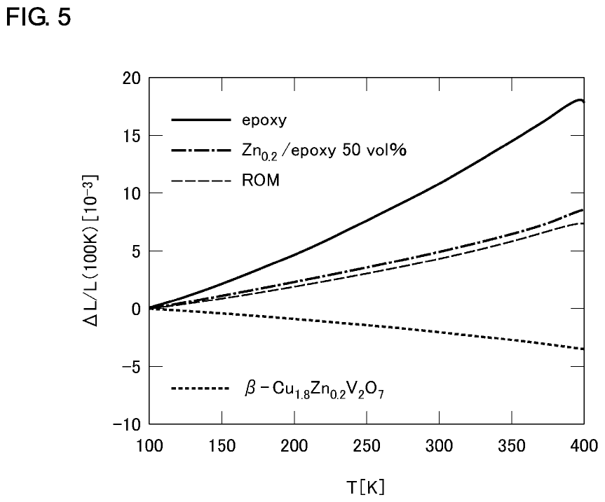

FIG. 5 is a diagram showing the thermal expansion property of a composite material according to the present embodiment. The composite material shown in FIG. 5 is a mixture of 50 vol % of β-Cu_{1.8}Zn_{0.2}V₂O₇ having a linear expansion coefficient α of −14 ppm/K and 50 vol % of an epoxy resin having a linear expansion coefficient α of 60 ppm/K. As shown in FIG. 5, in the composite material according to the present embodiment, the thermal expansion (volume change) with respect to the temperature change is largely suppressed as compared with the case of an epoxy resin alone. Instead of the epoxy resin, a resin material such as an engineering plastic, a polyvinyl butyral resin, or a phenol resin, or a metal material such as aluminum may be included.

The line described as ROM (Rule of Mixture) in FIG. 5 indicates an ideal linear expansion coefficient when two materials having different linear expansion coefficients are mixed at a predetermined volume fraction, and the line almost matches the linear expansion coefficient measured for the composite material according to the present embodiment.

In β-Cu_{1.8}Zn_{0.2}V₂O₇ explained in the present embodiment, ΔV/V (unit cell) associated with a temperature rise in terms of a unit cell of the crystal is much smaller than ΔV/V (bulk) associated with a temperature rise in terms of the whole oxide sintered compact. More specifically, when the temperature of the sintered compact of β-Cu_{1.8}Zn_{0.2}V₂O₇ is raised from 200K to 700K, the lattice constant of a monoclinic crystal (β phase) changes by −1.6% in the a axis, 1.1% in the b axis, and −0.3% in the c axis, and −0.1% in the angle β, and ΔV/V (unit cell) is −0.8%. Therefore, ΔV/V (unit cell) is only about one third of ΔV/V (bulk), which is −2.6%, shown in Table 1.

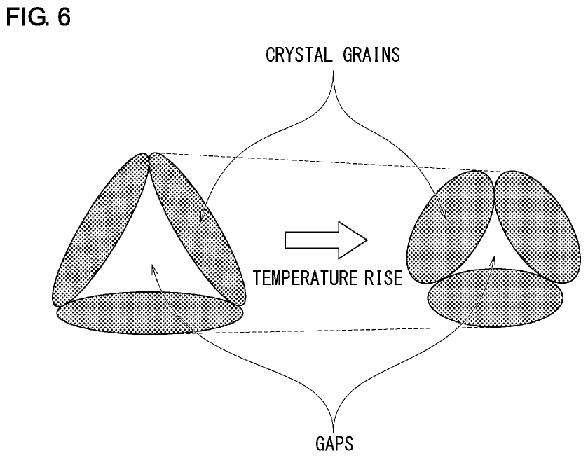

FIG. 6 is a schematic diagram for explaining a significant discrepancy between ΔV/V (unit cell) and ΔV/V (bulk). As shown in FIG. 6, in the sintered compact (ceramics), there are pores between the crystal grains. Further, the negative thermal expansion of the crystal does not always change isotropically in size, and in the case of β-Cu_{1.8}Zn_{0.2}V₂O₇, the crystal shrinks in the directions of the a axis and the c axis as described above but expands in the direction of the b axis. Therefore, if there is a gap in the direction of the b axis, the expansion of the crystal in the direction of the b axis is absorbed in the gap. Thus, it is considered that the negative thermal expansion is large as a whole in the sintered compact.

As described above, in the negative thermal expansion material according to the embodiment of the present disclosure, the linear expansion coefficient is substantially constant under temperature change in a wide temperature range of about 100 to 700K, and material function designing is thus easy. Further, there are industrial merits such as being composed mainly of inexpensive elements such as Cu, Zn, and V and being oxides having low synthesis temperature that allows for easy manufacturing.

Described above is an explanation of the present disclosure based on the embodiments. These embodiments are intended to be illustrative only, and it will be obvious to those skilled in the art that various modifications to constituting elements and processes could be developed and that such modifications are also within the scope of the present disclosure.

### INDUSTRIAL APPLICABILITY

The oxide sintered compact represented by the general formula (1): Cu₂₋ₓRₓV₂O₇ (R is at least one element selected from Zn, Ga, and Fe) or the general formula (2): Cu₂V₂₋ₓMoₓO₇ of the present disclosure can be used as a thermal expansion suppressor for canceling out and suppressing thermal expansion usually exhibited by a material. Further, zero thermal expansion materials can be also made that do not expand positively or negatively in a particular temperature range.

More specifically, the oxide sintered compact can be used for precision optical components and mechanical components, process equipment and tools, temperature compensation materials for fiber gratings, printed circuit boards, encapsulants for electronic components, thermal switches, refrigerator parts, satellite parts, and the like that disfavor changes in shape and/or dimensions due to temperature. In particular, by using a composite material in which a negative thermal expansion material is dispersed in a matrix phase of a resin having a large positive thermal expansion coefficient, thermal expansion can be suppressed and controlled even in a resin material, and thus usage in various applications can be possible.

What is claimed is:

1. A negative thermal expansion material that is represented by a general formula (1): Cu₂₋ₓRₓV₂O₇ (R is at least one element selected from Zn, Ga, and Fe) and that comprises an oxide sintered compact whose linear expansion coefficient is −10 ppm/K or less.

2. The negative thermal expansion material according to claim 1, wherein x in the general formula (1) is 0.1 to 0.2.

3. The negative thermal expansion material according to claim 1, wherein R is Zn.

4. The negative thermal expansion material according to claim 3, wherein x in the general formula (1) is 0.15 to 1.

5. A negative thermal expansion material that is represented by a general formula (2): Cu₂V₂₋ₓMoₓO₇ and that comprises an oxide sintered compact whose linear expansion coefficient is −10 ppm/K or less.

6. The negative thermal expansion material according to claim 5, wherein x in the general formula (2) is 0.1 to 0.2.

7. The negative thermal expansion material according to claim 1, wherein the oxide sintered compact is in a monoclinic β phase.

8. The negative thermal expansion material according to claim 1, wherein the linear expansion coefficient is −10 ppm/K or less in a temperature range of 100 to 700K.

9. A composite material comprising:
the negative thermal expansion material according to claim 1; and
a positive thermal expansion material having a positive linear expansion coefficient.
